(19) United States
(12) Patent Application Publication
(10) Pub. No.: US 2003/0031471 A1
(43) Pub. Date: Feb. 13, 2003

(54) Infrared radiator with a twin envelope tube

(76) Inventors: Friedhelm Schneider, Gilnhausen (DE); Werner Kreuter, Hanau (DE); Jurgen Schaack, Karlstein (DE)

Correspondence Address: FULBRIGHT & JAWORSKI, LLP, 666 FIFTH AVE, NEW YORK, NY, 10103-3198, US

(21) Appl. No.: 10/183,079

(22) Filed: Jun. 27, 2002

(30) Foreign Application Priority Data
Aug. 7, 2001 (DE) 101 37 928.5-33

(51) Int. Cl. F26B 3/30

(52) U.S. Cl. 392/407

(57) ABSTRACT

An infrared radiator with a twin envelope tube and at least one elongated infrared radiator element situated therein, which has at each of two oppositely lying ends a contact area for an electrical connecting conductor, at least one of which is carried through the seal of the envelope tube by means of an enclosed molybdenum film to an outwardly lying connection contact.

### FIELD OF THE INVENTION

The invention relates to an infrared radiator with a twin envelope tube and at least one elongated infrared radiator element situated therein, which has at each of two oppositely lying ends a contact area for an electrical connecting conductor, at least one of which is carried through the seal of the envelope tube by means of an enclosed molybdenum film to an outwardly lying connection contact.

### BACKGROUND OF THE INVENTION

EP 0 959 645 A2 discloses a short-wavelength infrared surface radiator which has a plurality of infrared radiator elements, each surrounded by an envelope tube which hermetically encloses a heating coil. For electrical connection the infrared radiator elements are attached to a molybdenum film which is fused within the envelope tube and at the terminal end is brought out of the envelope tube by means of a rod for electrical connection; at the same time a plurality of infrared radiators are connected together to form a common radiation plane and arranged parallel to one another, each connection end of the envelope tubes being bent away with respect to the plane of radiation.

In a preferred embodiment the envelope tubes are each bent away in the area of the seal by an angle ranging between 46 and 135°.

Also, DE 195 45 296 discloses an infrared radiator which has a flattened radiation source in the form of a carbon ribbon, the ends of the ribbon being provided at least partially with a metallic contact layer which is engaged by connecting elements.

GB-A 22 33 150 discloses an infrared radiator with a carbon ribbon, which consists of a plurality of graphite fibers disposed parallel to one another and in the form of a strip which is arranged inside of a quartz glass tube sealed at both ends. The carbon ribbon is provided at both ends with metal end caps for electrical connection.

It has been found problematical in carbon radiators that flexibility is limited in the selection of the electrical voltage, since all that is involved is an elongated carbon fiber ribbon; thus also the electric power is not adjustable at will.

### SUMMARY OF THE INVENTION

The problem of the invention is to use carbon radiators in varying arrangement in twin tubes by using known twin-tube technology, so that a greater flexibility is achieved in the selection of the electrical voltage.

The problem is solved in that the infrared radiator element is at least one carbon ribbon arranged at a distance from the inner surface of the envelope tube, the carbon ribbon having a contact area at each of its ends for connection to metal conductors, and at least one metal conductor is configured as a tension spring.

It proves to be advantageous that carbon radiators offer a high thermal speed in comparison with metal heating conductors, so that they are comparable in their heating and cooling behavior to short-wave radiation.

In one advantageous embodiment of the radiator, a filling gas is used in the interior of the twin envelope tube, which contains noble gas; preferably argon is used as the filling gas, with a cold fill pressure ranging from 500 to 900 mbar.

In practice, a radiator can be used in which at least one carbon ribbon reaches to only a portion of the length of the interior of the envelope tube. Advantageously, the interior of the envelope has an at least approximately elliptical cross section, the main axis of the ellipse of the cross section running parallel to the surface of the carbon ribbon.

Furthermore, it is possible for the interior of the envelope tube to have an at least approximately circular cross section; in such a case the center of the circular cross section lies in the area of the carbon ribbon.

Furthermore, the utilization pursuant to the invention of twin-tube technology permits a varied arrangement of twin tubes, so that on the one hand it is possible to vary the connected electrical voltage through the length of the carbon ribbon; furthermore, it is now advantageously possible to achieve carbon radiators with a total length of up to 3 meters.

An additional advantage is to be seen in the fact that, due to the compact geometry of the twin tubes, higher powers per unit area are possible, and twin tubes are also more stable mechanically than single round tubes and therefore in practice—in drying lacquer for example—they assure great safety of operation. Furthermore, due to the elliptical or circular cross section of the interior space, good thermal insulation of the carbon radiator is achieved. Advantageous embodiments of the invention are given in the subordinate claims.

The subject matter of the invention will be further explained below with the aid of FIGS. 1, 2a, 2b, 3 and 4.

### BRIEF DESCRIPTION OF THE DRAWINGS

FIG. 1 shows in longitudinal section a twin envelope tube of quartz glass with its power connection at one end, in which one tube has a carbon ribbon as infrared radiator with tension spring, while the adjacent twin tube has only one power conductor stretched with a tension spring.

FIG. 2a shows a twin tube radiator with power connection at one end and a carbon radiator in each of the two twin tubes.

FIG. 2b shows a cross section taken along the cross-sectional area indicated by line A-A in FIG. 2.

FIG. 3 shows a twin tube radiator with power connections brought out separately at both ends of the radiating system.

FIG. 4 shows a twin tube radiator with one divided carbon ribbon in each twin tube.

### DETAILED DESCRIPTION

According to FIG. 1 the infrared radiator 1 has two tubes fixedly joined mechanically together by fusion as a quartz glass twin tube, which has at one end one power lead-through in each tube, each with a seal area or pinched area 4 through which a molybdenum sealing film 3 is brought. The molybdenum film hermetically seals off the argon-filled interior from the external atmosphere. Inside of the first tube 1′ is a carbon ribbon 2 whose ends are connected each with a contact area 6 for connection to metal conductors; at one end of the carbon ribbon 2 an electrically conductive spring element 7 is electrically and mechanically connected to compensate for thermal expansions of length, the spring element being provided with a connecting conductor which bears the inwardly directed contact with the molybdenum film. The other end of the carbon ribbon is connected by a conductor in the form of a shunt 9 to an electrical conductor 10 in the adjacent tube 1″. The conductor 10 is provided with a spring element for compensation of thermal elongation, so that when the current flows no expansion problems can occur in the conductor. The conductor 10 is connected in the seal area 4 to the inwardly pointing end of the molybdenum film, so that the circuit for the carbon ribbon can be closed via the external terminals 5′, 5′ of the connection 5.

Thus it is a matter of a radiator with a twin envelope tube which has an electrical connection at one end and a single-channel heater; its great mechanical stability in operation based on the twin-tube design with a central seam proves advantageous.

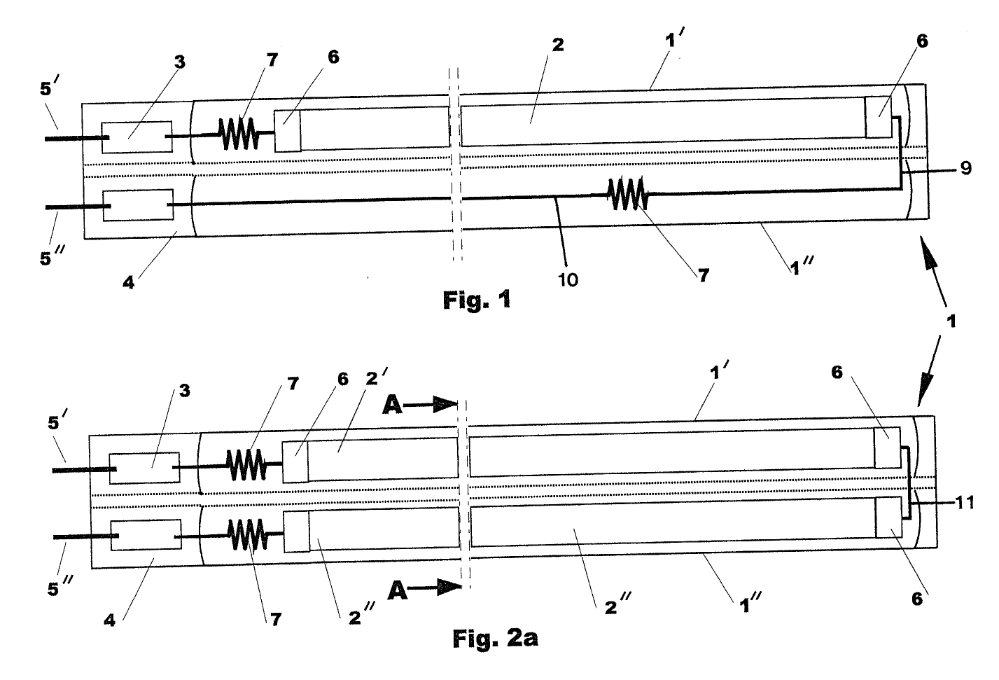

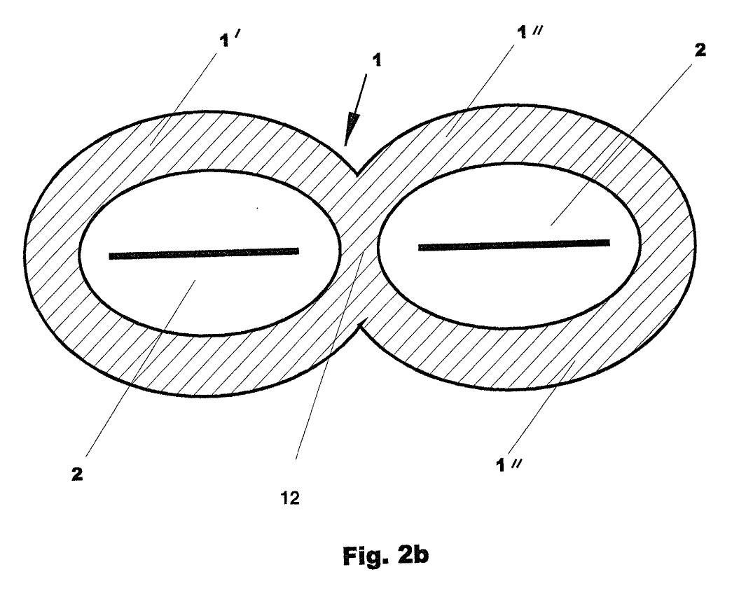

FIG. 2a shows in longitudinal section a twin-tube system which has in each tube 1′, 1″ a carbon ribbon 2′, 2″ over nearly the full length of the interior space, containing connection areas 6 situated at the ends, which is joined by conductors, spring elements 7 and a shunt 11. The conductors in the interior are formed between the contacts of the ribbons 6 and the particular molybdenum sealing films 3 as spring elements 7 for compensation of the thermal elongation of the carbon ribbons 2′, 2″.

FIG. 2b shows a cross section taken along a surface which is represented schematically as line M in FIG. 2a.

According to FIG. 2b, the two twin tubes 1′, 1″ are made into a single double tube 1 joined fixedly together mechanically, whose outer circumference results from the twin-tube configuration 1′, 1″, so that the twin tubes are now combined to form a single radiator. An important feature for improving mechanical stability, especially in the case of great thermal stress, is to be seen in the middle seam 12. Due to biasing by spring elements a great stability of the infrared radiator system is achieved on the one hand, while on the other hand a sufficient space exists between carbon radiator ribbons 2, 2′ and 2″ and the twin tube configuration, so that a rapid thermal reaction of the carbon ribbon is made possible by thermal insulation.

The radiator is thus one with terminals at one end and two-channel heating.

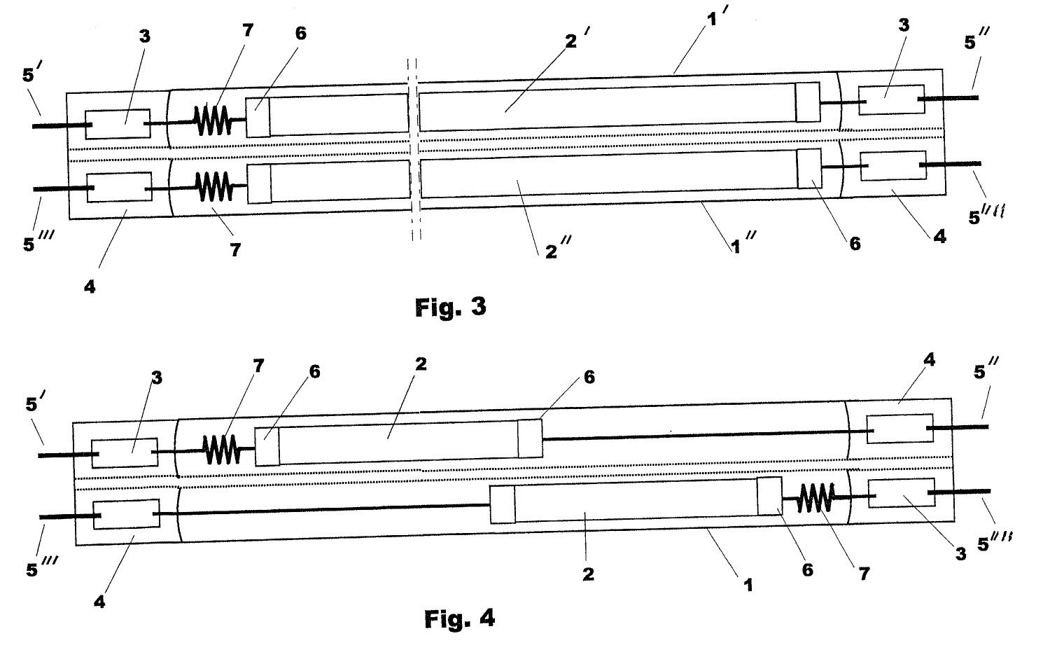

FIG. 3 shows an embodiment similar to FIG. 2a, but here the twin tube radiator has two carbon ribbons 2 which can be supplied with power independently of one another. The external terminals 5′, 5″ and 5′″, 5″″ are brought out by their own leads at opposite ends, and the carbon ribbons can be turned on and off as infrared radiator elements, each through its own control current circuit, independently of one another. It is possible by different kinds of power supply to produce even different spectral portions, for example for irradiation purposes or drying purposes. The functions of seal areas 4, molybdenum films 3, and spring elements 7, are already known from the description of FIG. 1, so that further explanations are not given.

This is therefore a radiator with terminals at both ends and two-channel heating.

FIG. 4 shows a twin-tube configuration with external terminals 5′, 5″, 5′″, 5″″ (as in FIG. 3), in the two twin tubes 1′, 1″ of which carbon ribbons 2 only partially tensed by tension springs 7 are provided, the latter complementing one another along their long axes such that the infrared radiation occurs over the entire length of the radiator. This configuration proves especially good for achieving long lengths of radiation—ranging from 3 to 6 m in length—which can be produced by shorter carbon ribbons overlapping in the side-by-side channels of the twin tubes.

It is claimed:

1. Infrared radiator having a twin envelope tube and at least one elongated infrared element therein, which has at each of two oppositely lying ends a contact area for an electrical connecting line, of which at least one connecting line is carried through a seal of the envelope tube by means of enclosed molybdenum film to an externally lying connecting contact, characterized in that as infrared radiator element at least one carbon ribbon (2, 2′, 2″) is disposed at a distance from the inner surface of the envelope tube (1, 1′, 1″), the carbon ribbon having at each of its ends one contact area (6) for connection to metal conductors, and at least one metal conductor is configured as an tension spring (7).

2. Radiator according to claim 1, characterized in that a filling gas which contains noble gas is inserted in the interior of the twin-envelope tube (1, 1′, 1″).

3. Radiator according to claim 2, characterized in that argon is used as filling gas with a cold filling pressure ranging from 500 to 900 mbar.

4. Radiator according to any one of claims 1 to 3, characterized in that at least one carbon ribbon (2, 2′, 2″) reaches over only a portion of the length of the interior of the envelope tube (1, 1′, 1″).

5. Infrared radiator according to any one of claims 2 to 4, characterized in that the interior of the envelope tube (1, 1′, 1″) has an at least approximately elliptical cross section.

6. Infrared radiator according to claim 5, characterized in that the main axis of the ellipse of the cross section runs parallel to the surface of the carbon ribbon (2, 2′, 2″).

7. Infrared radiator according to any one of claims 1 to 4, characterized in that the interior of the envelope tube (1, 1′, 1″) has an at least approximately circular cross section.

8. Infrared radiator according to claim 7, characterized in that the center of the circular cross section is in the carbon ribbon (2, 2′, 2″) area.

9. An infrared radiator comprising:
a twin envelope tube and at least one elongated infrared element therein, which has at each of two oppositely lying ends a contact area for an electrical connecting line, of which at least one connecting line is carried through a seal of the envelope tube by means of enclosed molybdenum film to an externally lying connecting contact, at least one carbon ribbon is disposed at a distance from the inner surface of the envelope tube the carbon ribbon having at each of its ends one contact area for connection to metal conductors, and at least one metal conductor is configured as a tension spring.

10. An infrared radiator according to claim 9, wherein a filling gas which contains noble gas is inserted in the interior of the twin-envelope tube.

11. An infrared radiator according to claim 10, wherein said filling gas is argon with a cold filling pressure ranging from 500 to 900 mbar.

12. An infrared radiator according to claim 9, wherein at least one carbon ribbon reaches over only a portion of the length of the interior of the envelope tube.

13. An Infrared radiator according to claim 10, wherein the interior of the envelope tube has an at least approximately elliptical cross section.

14. An infrared radiator according to claim 13, wherein the main axis of the ellipse of the cross section runs parallel to the surface of the carbon ribbon.

15. An infrared radiator according to claim 9, wherein the interior of the envelope tube has an at least approximately circular cross section.

16. In infrared radiator according to claim 15, wherein the center of the circular cross section is in the carbon ribbon area.
